(19) United States
(12) Patent Application Publication
(10) Pub. No.: US 2011/0091631 A1
(43) Pub. Date: Apr. 21, 2011

(54) CULINARY FOAM

(76) Inventor: John Richard Pott, Berkshire (GB)

(21) Appl. No.: 12/581,427

(22) Filed: Oct. 19, 2009

(51) Int. Cl. A23L 1/00

(52) U.S. Cl. 426/564

(57) ABSTRACT

The invention provides a substantially fat-free composition which is, aerosol-dispensable as a culinary foam. The composition comprises in combination:
(i) 0.1 to 5% of at least one gum;
(ii) 0.1 to 5% of at least one thickener;
(iii) an anti-fungal agent;
(iv) nitrous oxide propellant;
(v) water, and
(vi) a sufficient amount of at least one organic acid to maintain the pH of the composition below 7.

### FIELD OF THE INVENTION

The present invention relates to a culinary (food) foam suitable for use as a food garnishing, or as a primary ingredient in a dish in all sectors of the menu.

Chefs have created edible foams since Auguste Escoffier published a first book in 1914. In modern day kitchens, chefs use canisters pressurised by nitrous oxide to create food foams that are added to prepared dishes both for garnishing and creating an additional flavour and texture to the dish being served or beverage being drunk. The sauces for such foams are made on an individual batch basis, and chefs experience inconsistent quality and variability between batches. This is due to inaccurate measurement of, varying combination of ingredients, inconsistent quality of the ingredients, varying levels of skill in mixing and gassing and human error. The sauces do not keep and have a short shelf life. Furthermore, the consistency of the foam is often not maintained, so that the bubble structure of the aerated sauce collapses before it is eaten, or may set to a jelly-like consistency, so losing its characteristics of an aerated sauce.

Temperature is an important factor in the preparation of sauces for the production of edible foams, as the incorporation of gelatine and/or agar commonly used in foams generated in the kitchen, result in variable characteristics according to temperature.

It is important that food foams have an attractive bubble structure, are of an acceptable flavour and feel good in the mouth, and so enhance the food to which they are applied. The temperature of the food to which edible foams are applied is highly variable: from ice cream and iced drinks to hot food and drinks.

Kitchen-generated foams often contain fats in emulsion. These have the advantage that the propellant gas, nitrous oxide, readily dissolves in lipids. Fat-based sauces foam if subject to nitrous oxide under pressure, and readily produce foam when released to atmospheric pressure as the gas is released from the lipid phase. As a result, pre-pressurised aerosol cans are readily available for dispensing whipped cream at home or for catering purposes. This is not so readily achieved with aqueous foams.

Attempts to produce culinary foams without the use of fats have tended to result in foams with inadequate shelf life. We theorize that this may be due to degradation of colours or flavours by nitrous oxide which is not dissolved in lipids. U.S. Pat. No. 4,882,182 describes an aerosol product with improved shelf life provided by use of a phosphate buffer system that maintains the pH of the composition in the range 8.0 to 8.5. A problem with the use of relatively high pH compositions is that the alkaline environment may enable bacteria to thrive and multiply.

### SUMMARY OF THE INVENTION

We have surprisingly found that by using a combination of an edible gum acid as foam stabilizer, a polysaccharide thickener, and an organic acid to maintain a pH below 7, preferably about 3 to about 4, a fat-free composition may have a good shelf life even when used with a nitrous oxide propellant. The composition forms an edible foam when dispensed from an aerosol, and the foam retains its bubble structure under a range of temperature conditions for a sufficient period of time for the foam to be consumed.

Accordingly, an aspect of the invention provides a substantially fat-free composition which is dispensable in a prepacked ready to use commercial aerosol can as a culinary foam, the composition comprising in combination:
(i) 0.1 to 5% of at least one gum;
(ii) 0.1 to 5% of at least one polysaccharide thickener;
(iii) an anti-fungal agent;
(iv) nitrous oxide propellant;
(v) water; and
(vi) a sufficient amount of at least one organic acid to maintain the pH of the composition below 7.

The invention provides a ready-to-use edible food-garnishing foam when dispensed from a disposable prepacked aerosol can for use in the kitchen, restaurant or bar. The foam is light and soft, with a pleasing taste and aroma, adequate bubble stability and attractive bubble structure with slow bubble coalescing properties.

In preferred embodiments, the food garnishing foam is formulated so that it substantially retains its foam structure after being dispensed, for at least ten minutes and up to twenty minutes or longer. This allows it to be applied to the food or drink and served to and consumed by the consumer, either at home or in a catering setting e.g. banqueting or restaurants.

In a preferred embodiment, the composition further comprises 0.1 to 5% of a polyacrylic acid. A variety of polyacrylic acid materials are suitable for use in the present invention, providing that they are soluble in water. A preferred type of polyacrylic acid is a Carbomer Homopolymer which is a high molecular weight polymer of acrylic acid crosslinked with allyl ethers or pentaerithritol. Such products are known in Europe as Carbomers, and in Japan as Carboxyvinyl polymers. Suitable products are sold by Lubrizol under the name Carbopol®, notably Carbopol 971P NF (previous name Carbomer 941), Carbopol 974P NF (previous name Carbomer 934P) and Carbopol 71G NF (previous name Carbomer 941). We have found that by using suitable polyacrylic acid additives, the resulting culinary foams may be stabilized for hours rather than minutes, while retaining acceptable organoleptic properties.

Examples of foams made from compositions in accordance with the invention retain bubble characteristics, flavour and colour when applied to food of varying temperature from 0° C. to 85° C.

We have found that the product retains its colour and flavour after storage in an aerosol can pressurised with nitrous oxide for a sufficient length of time to allow a reasonable storage period of at least 12 months (shelf life) at ambient temperature (and so does not require refrigeration). Even natural colours and flavours, which can be particularly prone to oxidative damage, have remained substantially unaffected in the presence of nitrous oxide at the end of the shelf life, judged by organoleptic stability tests.

Example formulations are summarised in Table 1.

The following abbreviations are used in Table 1.
Cell=cellulosic thickener (methyl cellulose, carboxymethylcellulose, or sodium carboxymethylcellulose);
MD=maltodextrose;
Carbomer=Carbopol® 974P NF Polymer (Lubrizol); a high molecular weight polymer of acrylic acid crosslinked with allyl ethers of pentaerithritol;
XG=Xanthan gum;
LBG=locust bean gum;
GG=guar gum;
AA=ascorbic acid (vitamin C);
CA=citric acid;
KS=potassium sorbate (anti-fungal);
qs=sufficient nitrous oxide to give a pressure of approximately 6-7 bar;
   All percentages are given by weight.

TABLE 1

| | | | | | | | | | | Fruit | Glucose | | Su- | | | Fla- | Nat. | |
|---|---|---|---|---|---|---|---|---|---|---|---|---|---|---|---|---|---|---|
| Ex. | Water | Cell. | MD | Carbomer | XG | LBG | GG | AA | CA | Extract | Syrup | Pectin | crose | Salt | KS | vour | Colour | N₂O |
| 1 | To 100 | 0.16 | | | 0.1 | .09 | | 0.03 | 0.11 | 111.18 | 4.43 | 0.28 | 13.05 | | 0.12 | 0.3 | 0.15 | qs |
| 2 | To 100 | 0.2 | 1.3 | | 0.1 | 0.1 | | 0.04 | 0.05 | 98.09 | | | | | 0.12 | | | qs |
| 3 | To 100 | 0.5 | | | 0.09 | 0.18 | | 0.04 | 0.25 | 17.0 | | 0.47 | 27.4 | | 0.11 | | | qs |
| 4 | To 100 | 0.99 | | 0.5 | 0.1 | 0.1 | | 0.04 | 0.19 | | | | | | 0.11 | 0.75 | | qs |
| 5 | To 100 | 0.14 | | | 0.16 | 0.19 | | 0.04 | 0.02 | | | | 0.01 | 0.72 | 0.12 | 0.76 | | qs |
| 6 | To 100 | 0.92 | | 0.73 | 0.29 | | | 0.04 | 0.11 | | | | 75.15 | | 0.1 | 0.85 | | qs |
| 7 | To 100 | 0.12 | | | 0.14 | 0.16 | | 0.04 | 0.18 | | | | 0.01 | 0.51 | 0.12 | 0.57 | | qs |
| 8 | To 100 | 0.8 | | | 0.1 | 0.98 | | 0.04 | 0.2 | 23.00 | | 0.5 | 19.00 | | 0.12 | | | qs |
| 9 | To 100 | 0.12 | | | 0.14 | 0.16 | | 0.04 | 0.13 | 5.07 | | | 6.1 | | 0.12 | | | qs |
| 10 | To 100 | 0.16 | | 0.65 | 0.1 | | 0.89 | 0.04 | 0.11 | 11.18 | 4.43 | 0.28 | 12.19 | | 0.12 | 0.65 | 0.2 | qs |

Example formulation details are given below. The sauces were tested by filling them into a 500 ml charger and gassed with nitrous oxide to form the foam on discharge. Additionally, a number of these example formulations have already been scaled up to the commercial production of half tonne quantities and filled into ready-to-use aerosol cans.

### EXAMPLE 1

Carboxymethylcellulose 0.16%, xanthan gum 0.1%, locust bean gum 0.09%, ascorbic acid 0.03%, citric acid 0.11%, natural fruit extract 11.18%, glucose syrup 4.43%, pectin 0.28%, sucrose 13.95%, potassium sorbate 0.12%, flavour 0.3%, natural colour 0.15%, nitrous oxide qs, water to 100%.

### EXAMPLE 2

Methylcellulose 0.2%, maltodextrose 1.3%, xanthan gum 0.1%, locust bean gum 0.1%, ascorbic acid 0.04%, citric acid 0.05%, fruit extract 98.09, potassium sorbate 0.12%, nitrous oxide qs, water to 100%.

### EXAMPLE 3

Methylcellulose 0.5.0%, xanthan gum 0.09%, locust bean 0.18%, ascorbic acid 0.04%, citric acid 0.25%, fruit extract 17.0%, pectin 0.47% sucrose 27.4%, potassium sorbate 0.11%, nitrous oxide qs, water to 100%.

### EXAMPLE 4

Sodium carboxymethylcellulose 0.99%, Carbomer 0.5%, xanthan gum 0.1%, locust bean gum 0.1%, ascorbic acid 0.04%, citric acid 0.19%, potassium sorbate 0.11%, natural flavour 0.75%, nitrous oxide qs, water to 100%.

### EXAMPLE 5

Sodium carboxymethylcellulose 0.14%, xanthan gum 0.18%, locust bean gum 0.1%, ascorbic acid 0.04%, citric acid, 0.19%, sucrose 0.01%, salt 0.72%, potassium sorbate 0.12%, natural flavour 0.76%, nitrous oxide qs, water to 100%.

### EXAMPLE 6

Sodium carboxymethylcellulose 0.92%, Carbomer 0.73%, xanthan gum 0.29%, sucrose 25.15%, ascorbic acid 0.04%, citric acid 0.11%, potassium sorbate 0.1%, natural flavour 0.85%, nitrous oxide qs, water to 100%.

### EXAMPLE 7

Methylcellulose 0.12%, xanthan gum 0.14%, locust bean gum 0.16%, sucrose 0.01%, ascorbic acid 0.04%, citric acid 0.18%, salt, 0.51%, potassium sorbate 0.12%, natural flavour 0.57%, nitrous oxide qs, water to 100%.

### EXAMPLE 8

Methylcellulose 0.8%, xanthan gum 0.08%, locust bean gum 0.98%, fruit extract 23.0%, sucrose 19.0%, pectin 0.5%, ascorbic acid 0.04%, citric acid 0.2%, potassium sorbate 0.12%, nitrous oxide qs, water to 100%.

### EXAMPLE 9

Methylcellulose 0.12%, xanthan gum 0.14%, fruit extract 5.07%, locust bean gum 0.16%, sucrose 6.1%, ascorbic acid 0.04%, citric acid 0.13%, potassium sorbate 0.12%, nitrous oxide qs, water to 100%.

### EXAMPLE 10

Methylcellulose 0.16%, High molecular weight polymer of acrylic acid crosslinked with allyl ethers of pentaerythritol 0.65%, xanthan gum 0.1%, guar gum 0.89%, ascorbic acid 0.04%, citric acid 0.11%, fruit extract 11.18%, glucose syrup 4.43%, pectin 0.28%, sucrose 12.19%, potassium sorbate 0.12%, flavour 0.65%, natural colour 0.2, nitrous oxide qs, water to 100%.

qs=sufficient nitrous oxide to give a pressure of approximately 6-7 bar

Microbiological test results for example compositions in accordance with embodiments of the invention are given in Table 2. In each case the pH of the composition was in the range 3 to 4, and measured values were within acceptable levels. In the case of Example A, the initial anaerobic colony count of 80 had reduced to less than 10 after 92 days, indicating that the composition had an antibacterial effect.

TABLE 2

Sample ref

| | | | |
|---|---|---|---|
| A | B | C | D |

Aerobic colony counts cfu/g over 51 days (92 days one sample only)

| | | | | |
|---|---|---|---|---|
| Day 1 | 80 | <10 | <10 | <10 |
| Day 12 | <10 | <10 | <10 | <10 |
| Day 26 | 40 | <10 | <10 | <10 |
| Day 51 | 30 | <10 | <10 | <10 |
| Day 92 | 10 | nd | nd | nd |

Mould colony counts cfu/g over 51 days

| | | | | |
|---|---|---|---|---|
| Day 1 | <10 | <10 | <10 | <10 |
| Day 12 | <10 | <10 | <10 | <10 |
| Day 26 | <10 | <10 | <10 | <10 |
| Day 51 | <10 | <10 | <10 | <10 |

Yeast colony counts cfu/g over 51 days

| | | | | |
|---|---|---|---|---|
| Day 1 | <10 | <10 | <10 | <10 |
| Day 12 | <10 | <10 | <10 | <10 |
| Day 26 | <10 | <10 | <10 | <10 |
| Day 51 | <10 | <10 | <10 | <10 |
| pH | 3.6 | 3.5 | 3.61 | 3.48 |

nd = not done

The pH and organoleptic properties of compositions in accordance with embodiments of the invention have remained acceptable in test samples for up to 13 months (the longest period measured to date).

Results for pH are summarised in Table 3, and organoleptic results are summarised in Table 4.

TABLE 3
pH of various formulations after storage at ambient temperatures
(pH measured at 20° C.)

| | | Manufacturing | | | |
|---|---|---|---|---|---|
| Batch No. | Flavour | date | Test date | Period | pH |
| 03/09/261 | Vanilla | 05/09/08 | 18/10//09 | 13 | 3.36 |
| | | | | months | |
| 03/09/262 | Vanilla | 07/01/09 | 18/10//09 | 10 | 3.32 |
| | | | | months | |
| 03/09/263 | Vanilla | 03/03/09 | 18/10//09 | 7 | 3.44 |
| | | | | months | |
| 03/09/264 | Truffle | 26/09/08 | 18/10//09 | 13 | 3.40 |
| | | | | months | |
| 03/09/265 | Raspberry | 26/09/08 | 18/10//09 | 13 | 3.08 |
| | | | | months | |
| 03/09/266 | Mushroom | 09/10/08 | 18/10//09 | 12 | 3.51 |
| | | | | months | |
| 03/09/267 | Mushroom | 19/10/08 | 18/10//09 | 12 | 3.70 |
| | | | | months | |
| 03/09/268 | Truffle | 02/10/08 | 18/10//09 | 12 | 3.57 |
| | | | | months | |
| 03/09/269 | Raspberry | 26/09/08 | 18/10//09 | 13 | 3.19 |
| | | | | months | |
| 03/09/270 | Mango & | 26/09/08 | 18/10//09 | 13 | 3.05 |
| | Passion | | | months | |
| | Fruit | | | | |
| 03/09/271 | Mango & | 03/10/08 | 18/10//09 | 12 | 3.03 |
| | Passion | | | months | |
| | Fruit | | | | |

TABLE 4
Organoleptic parameters of various formulations after
storage at ambient temperatures
Times determined at 20° C.

| | | | | | | | | Time for |
|---|---|---|---|---|---|---|---|---|
| | | | | | | | | bubbles to |
| | | | | | | | Mouth | disperse |
| Batch No. | Flavour | Age | Appearance | Taste | Colour | Odour | feel | (minutes) |
| 08/10/262 | Vanilla | 10 months | OK | OK | OK | OK | OK | 19 |
| 08/10/263 | Vanilla | 7 months | OK | OK | OK | OK | OK | 25 |
| 03/09/264 | Truffle | 12 months | OK | OK | OK | OK | OK | 26 |
| 03/09/265 | Raspberry | 12 months | OK | OK | OK | OK | OK | 15 |
| 03/09/266 | Mushroom | 11 months | OK | OK | OK | OK | OK | 18 |
| 03/09/267 | Mushroom | 12 months | OK | OK | OK | OK | OK | 20 |
| 03/09/268 | Raspberry | 13 months | OK | OK | OK | OK | OK | 30 |
| 03/09/269 | Mango and | 13 months | OK | OK | OK | OK | OK | 24 |
| | passion Fruit | | | | | | | |
| 03/09/270 | Truffle | 12 months | OK | OK | OK | OK | OK | 32 |
| 03/09/271 | Mango and | 12 months | OK | OK | OK | OK | OK | 22 |
| | passion Fruit | | | | | | | |

The time taken for bubbles to disperse was measured as the point at which approximately 75% of the bubbles were judged to have burst or collapsed. These times (for compositions containing gum and thickener) are adequate for many applications. However, formulations including Carbomer were found to be stable for more than 60 minutes, and in one case up to 2.5 hours, while retaining acceptable taste, colour, odour and mouth-feel characteristics.

The preferred pH value for the composition is in the range about 3 to about 4. A preferred way to set this value is to adjust levels of citric acid appropriately during manufacture; however it will be understood that other organic acids could be used for this purpose.

Various natural and/or artificial sweeteners, flavours and colouring agents may be used in the compositions. Various other additives such as fruit extracts and extract of pods such as vanilla may also be used without being significantly affected by the nitrous oxide propellant.

It will be understood by those skilled in the art that various edible gums may be used in the present invention. Non-limiting examples include guar gum, gum agar, gum arabic, gum ghatti, gum karaya, gum tragacanth, locust bean gum, tamarind gum, and xanthan gum. The quantity of a particular gum that is used will be determined by the specific film-forming properties of the gum and the viscosity of an aqueous solution of suitable concentration.

The articles ‘a’ and ‘an’ are used herein to mean ‘at least one’ unless the context otherwise requires.

Having thus described the invention, what is claimed is:

1. A substantially fat-free composition which is aerosol-dispensable as a culinary foam, the composition comprising in combination:
(i) 0.1 to 5% of at least one gum;
(ii) 0.1 to 5% of at least one thickener;
(iii) an anti-fungal agent;
(iv) nitrous oxide propellant;
(v) water; and
(vi) a sufficient amount of at least one organic acid to maintain the pH of the composition below 7.

2. A composition according to claim 1, wherein the amount of organic acid is sufficient to maintain the pH of the composition in the range about 3 to about 4.

3. A composition according to claim 1, wherein the organic acid is selected from the group comprising citric acid and ascorbic acid, and mixtures thereof.

4. A composition according to claim 1, which is substantially protein-free.

5. A composition according to claim 1, further comprising 0.1 to 5% of a polyacrylic acid.

6. A composition according to claim 5, wherein the polyacrylic acid is a high molecular weight polyacrylic acid crosslinked with allyl ethers of pentaerythritol.

7. A composition according to claim 1, wherein the thickener is at least one polysaccharide.

8. A composition according to claim 7, wherein the thickener is at least one of methyl cellulose, carboxymethylcellulose, sodium carboxymethylcellulose, or maltodextrose.

9. A composition according to claim 1, wherein the anti-fungal agent is a sorbate salt which is present in a concentration of 0.05 to 2%.

10. A composition according to claim 9, wherein the sorbate salt is potassium sorbate.

11. A composition according to claim 1, further comprising at least one additive selected from the group comprising a sweetener, a flavouring agent and a colourant.

12. A substantially fat-free composition which is aerosol-dispensable as a culinary foam, the composition comprising in combination:
(i) 0.1 to 5% of at least one gum;
(ii) 0.1 to 5% of at least one thickener;
(iii) 0.1 to 5% of high molecular weight polyacrylic acid crosslinked with allyl ethers of pentaerythritol;
(iv) an anti-fungal agent;
(v) nitrous oxide propellant;
(vi) water; and
(vii) a sufficient amount of at least one organic acid to maintain the pH of the composition below 7.
